(19) United States
(12) Patent Application Publication
(10) Pub. No.: US 2003/0096065 A1
(43) Pub. Date: May 22, 2003

(54) Efficient nonlinear optical polymers having high poling stability

(76) Inventors: Horst Berneth, Leverkusen (DE); Serguei Kostromine, Swisttal (DE); Rainer Hagen, Leverkusen (DE); Karsten Buse, Georgsmarienhutte (DE); Nils Benter, Bonn (DE); Ralph Bertram, Bonn (DE); Elisabeth Soergel, Bonn (DE); Akos Hoffmann, Bonyhad (HU)

Correspondence Address: BAYER CORPORATION, PATENT DEPARTMENT, 100 BAYER ROAD, PITTSBURGH, PA, 15205, US

(21) Appl. No.: 10/252,465

(22) Filed: Sep. 23, 2002

(30) Foreign Application Priority Data
Sep. 27, 2001 (DE) 10147724.4
Jul. 3, 2002 (DE) 10229779.7

(51) Int. Cl. C09K 19/38; F21V 9/00; C09K 19/52; C09K 19/60

(52) U.S. Cl. 428/1.1; 252/299.01; 252/299.1; 252/582; 428/1.3; 428/1.31

(57) ABSTRACT

An electrooptical component comprising a side-chain polymer having nonlinear optical properties is disclosed. The polymer having photoaddressable properties contains a) at least one azobenzene-based dye, b) at least one mesogenic grouping, c) optionally at least one additional monomer unit and d) optionally a solubility-improving monomer unit, with the proviso that b) is optional in the embodiments where the azobenzene-based dye is mesogenic. Examples of electrooptical components disclosed include modulators, electrostrictive actuators and piezoelectric sensor.

### FIELD OF THE INVENTION

The invention concerns photoaddressable side-chain polymers having non-linear optical properties and more particularly electrooptical components containing such polymers.

### SUMMARY OF THE INVENTION

An electrooptical component comprising a side-chain polymer having non-linear optical properties is disclosed. The polymer having photoaddressable properties contains a) at least one azobenzene-based dye, b) at least one mesogenic grouping, c) optionally at least one additional monomer unit and d) optionally a solubility-improving monomer unit, with the proviso that b) is optional in the embodiments where the azobenzene-based dye is mesogenic. Examples of electrooptical components disclosed include modulators, electrostrictive actuators and piezoelectric sensor.

### BACKGROUND OF THE INVENTION

After poling, the polymers according to the invention, as amorphous films, exhibit high and stable nonlinear optical effects. Owing to their high optical quality, the polymer films are suitable for the production of waveguide structures and modulators. Pyro- and piezo-electric effects also allow the material to be used as a sensor. Electrostrictive effects enable use as a mechanical actuator.

Nonlinear optical (NLO) polymers have been known for more than 20 years. With appropriate preparation, such polymers can exhibit high NLO effects. Potential technical applications for NLO polymers lie within the fields of optoelectronics, telecommunications, optical information processing, sensor technology and mechanics. Examples of concrete technical applications include ultrafast modulators, optical switches, movement sensors and micropumps. See in this respect, for example, V. P. Shibaev (ed.), “Polymers as Electrooptical and Photooptical Active Media”, Springer, New York (1995).

The first publications relating to NLO polymers originate from Meredith [G. Meredith et al., Macromolecules 15, 1385 (1982)] and Garito [A. Garito et al., Laser Focus 80, 59 (1982)]. To date, a large number of very different polymer systems have been produced and converted (mostly by poling) into a NLO-active state. Such systems include amorphous polymers [R. Gerhart-Multhaupt et al., Annu. Rep.—Conf. Electr. Insul. Dielectr. Phenom., 49-52 (1995)], liquid crystal polymers [C. Heldmann et al., Macromolecules 31(11), 3519-3531 (1998)], inorganic-organic hybrid materials [H. Jiang et al., Adv. Mater. 10(14), 1093-1097 (1998)] and amorphous supramolecular polymers [C. Cai et al., Advanced Materials 11(9), 745-749 (1999)].

The polymers are generally prepared in the form of films and integrated into the components as optical waveguides, mode converters and directional couplers. NLO polymers can be optimized to such an extent that they are superior in many fields to commercially established inorganic crystals, including lithium niobate (LiNbO₃) and lithium tantalate (LiTaO₃). Teng was the first to demonstrate the high potential of electrooptical components based on NLO polymers [C. C. Teng et al., Appl. Phys. Lett. 60, 1538 (1992)]. Only recently has considerable success been achieved in the field of polymer-integrated optics [L. Eldada et al., IEEE Journal of Selected Topics in Quantum Electronics 6(1), 54-68 (2000)].

The origin of optical nonlinearity is to be found at the molecular level: NLO dye molecules (“chromophores”) are the antennae for the incident light. Owing to their electron configuration, these molecular antennae radiate in a strongly nonlinear manner. NLO effects can be demonstrated macroscopically in all the chromophores present in the polymer.

NLO effects, especially the linear electrooptical effect or Pockels effect, are particularly important for electrooptical applications.

The said effect is made possible by NLO chromophores having a pronounced molecular optical nonlinearity β. β means first order hyperpolarizability. Maximisation of the β coefficient is a development target for NLO chromophores. An overview of the various classes of hyperpolarizable molecules is given by Dalton, for example [L. R. Dalton et al., Chem. Mater. 7, 1060 (1995)].

The extent of the Pockels effect is defined in the case of NLO polymers by the Pockels coefficients r₃₃ and r₁₃. They may be determined, for example, by the method of attenuated total internal reflection [B. H. Robinson et al., Chem. Phys. 245, 35-59 (1999)]. Maximisation of the said r values is a development target for the NLO polymers, because many applications, such as, for example, ultrafast modulators, can only be achieved technically through strong NLO effects. High r values allow the operating voltage of the modulators to be reduced, so that higher modulation frequencies are achieved with the same electrical power [Y. Shi et al., Science 288, 119-122 (2000)].

A necessary condition for the Pockels effect is the absence of centrosymmetrical order. This requirement applies macroscopically as well as on a molecular level. While it is fulfilled on the molecular level by the electron structure of each NLO chromophore (example: acceptor/donor-substituted azobenzene or stilbene derivatives), a centrosymmetrical orientational distribution of the NLO chromophores usually prevails macroscopically. The symmetry arises by statistical disordering of the molecular orientation and must first be broken by poling. Poling means that a preferred direction is induced in the orientational distribution by means of strong electric fields and/or by means of irradiation by light. Various poling methods have been established to date. An overview is given by Burland [D. M. Burland et al., Chem. Rev. 94, 31-75 (1994)] and Bauer [S. Bauer, J. Appl. Phys. 80(10), 5531-5558 (1996)]. Theoretical models for describing the poling process in amorphous and liquid crystal polymers are to be found, for example, in [Shibaev]/Chapter 5.

Equally as important for applications in sensor technology is the pyroelectric effect, which occurs after poling.

Further applications of the polymers, namely as sensors which are able to detect temperature changes or light intensity, are conceivable, because poled polymers exhibit both pyroelectric effects (current conduction in the case of temperature change) and photoconductive effects (change in conductivity as a result of illumination).

Optimization of the poling efficiency is a technological development target. The poling efficiency may be read off, for example, at the polar order parameter <cos³ θ>.

A high poling stability (over time and thermally) is technically relevant. It correlates directly with the long-term stability of the poling-induced orientational distribution and with its insensitivity to temperature changes.

In summary, the key properties of polymer-integrated optics for use in electrooptical applications (patent specifications U.S. Pat. No. 6,067,186, U.S. Pat. No. 5,892,859 and U.S. Pat. No. 6,194,120) are:

The possibility of preparing and poling the polymer in the form of a film.

Good optical quality of the polymer film.

High poling efficiency.

Good poling stability.

The following requirements of a NLO polymer are derived therefrom:

Strongly non-linear electronic response at the molecular level, synonymous with high molecular hyperpolarizabilities β.

Efficient uniaxial orientation of the chromophores by poling, so that high Pockels coefficients r may be produced by poling.

High orientational stability, thermally and over time, of the non-centrosymmetrical chromophore order caused by poling.

Low intrinsic absorption in the wavelength range used technically (standard wavelength ranges for light modulators and in telecommunications: about 1300 nm and about 1500 nm).

Avoidance of inhomogeneities by aggregate formation or microphase separation, which lead to scattering. This applies in respect of all process steps (production and integration of the polymer film, including poling).

Each chromophore and also each NLO polymer have specific application-related advantages and disadvantages. Polymers that to date best fulfil many of the key properties have recently been introduced [Y. Shi et al., Science 288, 119-122 (2000)]. In the chemical concept of Shi et al., the chromophores are thickened in the middle so that they are practically round in shape and may more easily be oriented in electric poling fields. Accordingly, it was possible to achieve r values that permitted the production of modulators having operating voltages in the region of 1 volt. The main problem with such polymers is, however, their inadequate long-term stability, which arises because the round chromophores are able to lose their orientation comparatively easily.

In general, most NLO polymers are thermodynamically unstable in the poled state and therefore exhibit slow but constant relaxations of orientation back into the statistically disordered centrosymmetrical state (physical aging).

According to the state of our knowledge, no NLO material is as yet able to exhibit such an advantageous property profile that it is used in electrooptical components.

There is accordingly a need for a NLO polymer that fulfils all application-relevant requirements simultaneously.

### DESCRIPTION OF THE DRAWINGS

FIG. 1 shows two views of the geometry of samples prepared by the procedure of Example 3.

FIG. 2 shows the arrangement for thermal polling using coronal discharge.

FIG. 3 shows interferometer arrangement for measuring electrooptical coefficients.

### DETAILED DESCRIPTION OF THE INVENTION

It has surprisingly been shown that the groups of polymers described in this Application fulfil the mentioned requirements.

The invention accordingly relates to the use of particular NLO polymers which, as a thin film, exhibit high and stable nonlinear optical effects after poling, in the production of electrooptical components. Because of their high optical quality, the said selected polymers are suitable for the production of flat structures as well as waveguide structures for modulators and sensors.

In addition, they are photoaddressable, that is to say they contain light-active molecules which are able to change their conformation under the action of light. As a result, possibilities open up for the three-dimensional changing of the refractive index and for increasing the poling efficiency.

Furthermore, the solubility of the polymers may be adjusted in a targeted manner, so that various simple or modified alcohols are suitable as solvents.

The NLO polymer is characterised in that

it contains at least one azobenzene dye. Such dye molecules (“chromophores”) have high molecular hyperpolarizabilities β of typically (100-5000)×10⁻³⁰ esu, preferably greater than 500×10⁻³⁰ esu. In addition, they are light-active in the sense that the absorbed light triggers isomerization cycles between the linear trans state and the angular cis state [C. S. Paik; H. Morawetz, Macromolecules 5, 171 (1972)]. The mobility of each azo dye molecule may be increased by the associated rearrangements, and consequently the poling efficiency may be increased by typically from 15 to 50%.

it contains at least one grouping that is anisotropic in terms of form (“mesogen” for short). The mesogens improve the stability, thermally and over time, of the r coefficients after poling. Provided the azo dye is of mesogenic nature, no further mesogen must be present.

it optionally contains a monomer unit which is incorporated for the targeted reduction of the chromophore and mesogen content in the polymer.

it optionally contains a molecular group which improves the solubility in one or more simple or modified alcohols, as compared with the same material without such a group. The said group is also used for adjusting the chromophore and mesogen content.

The Application relates to the use of side-chain polymers having nonlinear optical properties in the production of electrooptical components, containing

a) at least one azobenzene-based dye

b) at least one mesogenic grouping, which may also be identical with group a),

c) optionally a further monomer unit which serves to reduce the content of azobenzene dyes and mesogenic groupings in a targeted manner,

d) optionally a solubility-improving monomer unit.

The Application also relates preferably to the use of side-chain polymers having nonlinear optical properties in the production of electrooptical components, containing

a) at least one azobenzene dye,

b) at least one grouping having anisotropy of form,

c) at least one monomer selected from (VI) or (VIa)

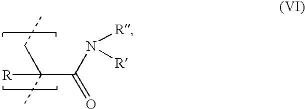

wherein

R′ and R″ either each independently of the other represents CₙH₂ₙ₊₁ or CₙH₂ₙ—OH, wherein n=from 1 to 10, preferably n=from 1 to 3, or together represent a —CₙH₂ₙ bridge wherein n=from 2 to 6, preferably n=from 4 to 5, a —(C₂H₄—O)ₙ—C₂H₄ bridge wherein n=from 1 to 5, preferably n=from 1 to 3, a —C₂H₄—N(CₙH₂ₙ₊₁)—C₂H₄ bridge wherein n=from 1 to 6, preferably n=from 1 to 3, and

R=H or methyl, and

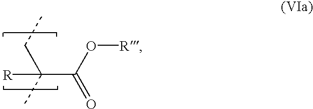

wherein

R′″ represents the radical —CₙH₂ₙ—OH, wherein n=from 1 to 10, preferably n=from 2 to 3, the radical —(C₂H₄—O)ₙ—H, wherein n=from 2 to 4, preferably n=2, the radical —CₙH₂ₙ—C(═O)NR″″R′″″,

wherein n=from 2 to 10, preferably n=from 2 to 5, particularly preferably n=2, where

R″″ and R′″″ either each independently of the other represents CₙH₂ₙ₊₁ or CₙH₂ₙ—OH, wherein n=from 1 to 10, preferably n=from 1 to 3, or together represent a —CₙH₂ₙ bridge wherein n=from 2 to 6, preferably n=from 4 to 5, a —(C₂H₄—O)ₙ—C₂H₄ bridge wherein n=from 1 to 5, preferably n=from 1 to 3, a —C₂H₄—N(CₙH₂ₙ₊₁)—C₂H₄ bridge wherein n=from 1 to 6, preferably n=from 1 to 3, and

R=H or methyl,

d) optionally further monomer units which are incorporated for the targeted reduction of the dye and/or mesogen content in the material.

Mesogens typically have a rod form, which is achieved by a linear, rigid molecule part. The length-breadth ratio, measured at the van-der-Waals radii, must be at least 4, preferably from 4 to 6. The anisotropy of form leads to anisotropy of the molecular polarizability. This type of molecule is described in the standard literature [H. Kelker, R. Hatz, “Handbook of Liquid Crystals”, Verlag Chemie (1980)] [L. Bergmann; C. Schaefer “Lehrbuch der Experimentalphysik”, Verlag de Gruyter, Volume 5 “Vielteilchensysteme” (1992)].

An azobenzene dye, present in the isomeric trans state, is also regarded as a mesogenic molecular unit if it fulfils the mentioned condition for anisotropy of form. If the azobenzene dye contained in the polymer is a mesogenic unit, it is not absolutely necessary for a further mesogenic unit to be present.

By means of the chemical composition of the polymer, the interactive forces between the functional units (chromophores and mesogens) are so adjusted that high stability of the r coefficients after poling is achieved on the one hand, and good mobility of the molecules during poling, which is ultimately the basic requirement for high r coefficients, is maintained on the other hand. Interactive forces are to be understood as being, inter alia, geometric forces, entropic forces and dipolar forces.

The orientational relaxations (physical ageing) present in the case of poled amorphous polymers and brought about by thermodynamic instability are greatly reduced in the polymers according to the invention by the incorporated mesogens.

The stability is so good that the requirements laid down in the Telecordia standard may be fulfilled. This includes long-term stability and also poling stability at higher temperatures.

By optimizing the chemical composition of the polymer, the r coefficients are also maximised. The chromophore content and the mesogen content are so adjusted that the optimum compromise is reached between maximum possible chromophore density and minimum possible intermolecular screening effects, with the result that the macroscopically measurable r coefficients are smaller than would be expected from the sum of the molecular effects.

The high hyperpolarizability β of the chromophores according to the invention and the efficient polarizability of the polymers permit the achievement of r coefficients greater than 30 pm/V, measured in the red spectral region and greater than 10 pm/V in the long-wave limit without resonance step-up.

Poled polymers with high r values also exhibit other physical effects, which may be used for numerous further applications. These are described briefly hereinbelow.

It has been found that polymers according to the invention exhibit a pyroelectric effect after poling, that is to say that, when there is a temperature change between the end surfaces lying perpendicular to the poling direction, a current conduction is induced on contacting. The strength of the said current conduction is proportional to the temperature change.

Crystals that exhibit this property have long been used in commercial temperature sensors (“movement detectors”). With adequate effects, the polymers could offer an inexpensive alternative.

In the case of these further applications using pyroelectric, photoconductive, piezoelectric and electrostrictive effects, it is generally the case that poled polymers, in which the r values have been optimized, exhibit the mentioned effects particularly strongly. The values achieved are competitive with respect to those of the compounds used hitherto. The polymers are also distinguished by flexible processing.

In order to produce thin, homogeneous films of large area and of high optical quality, various pouring, dropping or coating processes may be used. A standard process is spin coating. In the said process, a polymer is dissolved and the solution is applied dropwise to a rotating substrate. After evaporation of the solvent, a thin film of the recording material remains.

Once preparation has taken place, the polymers are in the form of films which are amorphous or have been rendered amorphous, that is to say a liquid crystal phase is suppressed and the amorphous state is frozen in the glass-like solidified polymer. It is a feature of the polymers according to the invention that should be given special mention that the poling-stabilizing action of the mesogens, which have the power to form a liquid crystal phase, is retained in the said state.

At the same time, the amorphous polymer film has high optical quality, which leads to reduced light scattering. As a result, the overall losses are kept small. In the wavelength ranges of about 1300 nm and about 1500 nm which are of interest for telecommunications, the polymers exhibit low optical attenuation, typically from 1 to 3 dB/cm.

A second advantage of low scattering is that the material may be used for the simultaneous modulation of a plurality of light waves or entire images with low signal crosstalk or low image noise.

The polymers are in principle compatible with the standard process techniques of the semiconductor industry, that is to say photolithography, reactive ion etching, laser ablation, pouring and embossing. They may therefore be of very different structures and integrated into optical/electrooptical components.

Since the polymers are light-active by way of the azobenzene dyes they contain, waveguide structures may additionally be generated also by the light-induced three-dimensional change in the refractive index, for example by operating the waveguide structure with polarized focused laser light or by homogeneous illumination with a mask arranged in front. The driving forces are again the isomerization cycles of the azobenzenes. Under the action of light, these lead to cooperative directed rearrangements of the azobenzenes in conjunction with the mesogens. Since the light-induced molecular rearrangements are reversible, the waveguide structures may be cancelled again, for example by homogeneous illumination of the polymer film with circularly polarized light.

After application to a substrate, the polymer is not in a nonlinear optical state. The directed orientation of the molecules and hence the nonlinear properties must first be induced by poling. All customary poling methods may be used. Preference is given to thermal poling, for example by means of corona discharge or contact electrodes. In that case, the polymer film is heated to a temperature close to the glass transition temperature (typically not more than 20° K difference). The glass transition temperature may be determined, for example, according to B. Vollmer, Grundriss der Makromolekularen Chemie, p. 406-410, Springer-Verlag, Heidelberg 1962. When that maximum so-called poling temperature is reached, electric poling fields of typically from 10 to 200 V/μm are applied for from 10 to 30 minutes. With the field applied, the polymer is slowly cooled to room temperature. Typical cooling rates are in the range from 0.2 to 5 K/min. The poling field may then be cut off and the polymer remains in a nonlinear optical state, that is to say it exhibits the Pockels effect.

The poling efficiency may be increased further by irradiation with light. In the case of such so-called light-assisted poling, the polymer is irradiated with light (monochromatically or continuously) before poling and/or during heating and/or during poling at the maximum temperature. The wavelength range from 390 nm to 568 nm, particularly preferably from 514 nm to 532 nm, is preferred. The light intensities are from 1 to 1000 mW/cm², preferably from 10 to 200 mW/cm², particularly preferably 100 mW/cm². The illumination times are from 1 s to 30 min, preferably from 10 s to 5 min. The direction of propagation of the light runs parallel or antiparallel to the electric field lines.

In a particular embodiment of the said poling technique, the polymer film remains at room temperature during poling. At the beginning of poling, the polymer film is irradiated with light as above. After the illumination, the poling field remains connected for typically from 5 to 30 min.

The NLO polymer according to the invention is preferably polymeric or oligomeric, organic, amorphous material, particularly preferably a side-chain polymer.

The main chains of the side-chain polymer come from the following basic structures: polyacrylate, polymethacrylate, polyacrylamide, polymethacrylamide, polysiloxane, polyurea, polyurethane, polyester, polystyrene or cellulose. Polyacrylate, polymethacrylate and polyacrylamide are preferred.

The main chains may contain monomeric units other than the said basic structures. These are monomer units of formula (VI) according to the invention.

The polymers according to the invention are generally in an amorphous state below the clarification temperature.

The polymers and oligomers according to the invention preferably have glass transition temperatures T_{g} of at least 40° C. The glass transition temperature may be determined, for example, according to B. Vollmer, Grundriss der Makromolekularen Chemie, p. 406-410, Springer-Verlag, Heidelberg 1962.

The polymers and oligomers according to the invention have a molecular weight, determined as the weight-average, of from 5000 to 2,000,000 g/mol, preferably from 8000 to 1,500,000 g/mol, determined by gel permeation chromatography (calibrated with polystyrene).

In the polymers preferably used according to the invention, azo dyes, generally separated by flexible spacers, are covalently bonded to the polymer main chain as the side chain. The azo dyes interact with the electromagnetic radiation and thereby change their spatial orientation, so that birefringence may be induced in the polymer by means of the action of light and cancelled again.

The mesogens are generally bonded in the same manner as the azo dyes. They do not necessarily have to absorb the actinic light, because they act as a passive molecule group. They are therefore not photoactive in the above sense. Their purpose is to enhance the light-induced birefringence and stabilize it after the action of light.

The molecular groups incorporated to improve the solubility of the polymer may be incorporated in three different ways:

1. As monomer units, integrated randomly into the main chains. Such monomer units are not functionalized with azobenzenes or mesogens.

2. As a side group at the site of binding between the azobenzene and the spacer.

3. As an end group at the free end of the azo dye.

The polymers according to the invention may at the same time contain azobenzenes that have been modified according to descriptions 2 and 3.

The polymers according to the invention may contain, in addition to azobenzenes that have been modified according to descriptions 2 and 3, monomer units according to the description of point 1.

Azo dyes preferably have the following structure of formula (I)

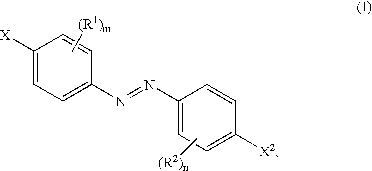

wherein

R¹ and R²each independently of the other represents hydrogen or a non-ionic substituent, and

m and n each independently of the other represents an integer from 0 to 4, preferably from 0 to 2.

X¹ and X² represent —X^{1′}—R³ or X^{2′}—R⁴,

wherein

X^{1′} and X^{2′} represent a direct bond, —O—, —S—, —(N—R⁵)—, —C(R⁶R⁷)—, —(C═O)—, —(CO—O)—, —(CO—NR⁵)—, —(SO₂)—, —(SO₂—O)—, —SO₂—NR⁵)—, —(C═NR⁸)— or —(CNR⁸—NR⁵)—,

R³, R⁴, R⁵ and R⁸ each independently of the others represents hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)— or

X^{1′}—R³ and X^{2′}—R⁴ may represent hydrogen, halogen, cyano, nitro, CF₃ or CCl₃,

R⁶ and R⁷each independently of the other represent hydrogen, halogen, C₁ to C₂₀-alkyl, C₁- to C₂₀-alkoxy, C₃- to C₁₀-cycloalkyl, C₂- to C₂₀-alkenyl or C₆- to C₁₀-aryl.

Non-ionic substituents are to be understood as being halogen, cyano, nitro, C₁- to C₂₀-alkyl, C₁- to C₂₀-alkoxy, phenoxy, C₃- to C₁₀-cycloalky, C₂- to C₂₀-alkenyl or C₆- to C₁₀-aryl, C₁- to C₂₀-alkyl-(C═O)—, C₆-to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—.

The alkyl, cycloalkyl, alkenyl and aryl radicals may themselves be substituted by up to 3 radicals from the group halogen, cyano, nitro, C₁- to C₂₀-alkyl, C₁- to C₂₀-alkoxy, C₃- to C₁₀-cycloalkyl, C₂- to C₂₀-alkenyl or C₆-to C₁₀-aryl, and the alkyl and alkenyl radicals may be straight-chain or branched.

Halogen is to be understood as being fluorine, chlorine, bromine or iodine, especially fluorine or chlorine.

Azo dyes that have solubility-improving properties within the scope of the invention are also to be described according to formula (I) including the meanings indicated above, wherein, however, R⁵ represents C₂- to C₁₀-alkyl-OH, preferably C₂- to C₄-alkyl-OH, or CH₂—(CH—OH)—CH₂—OH.

X¹ (or X²) represents a spacer group especially having the meaning X^{1′}-(Q¹)ᵢ—T¹—S¹—,

wherein

X^{1′} is as defined above,

Q¹ represents —O—, —S—, —(N—R⁵)—, —C(R⁶R⁷)—, —(C═O)—, —(CO—O)—, —(CO—NR⁵)—, —(SO₂)—, —(SO₂—O—)—, —(SO₂—NR⁵)—, —(C═NR⁸)—, —(CNR⁸—NR⁵)—, —(CH₂)ₚ—, p- or m-C₆H₄- or a divalent radical of the formula

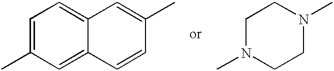

i represents an integer from 0 to 4, with the proviso that the individual Q¹ to have different meanings when i>1,

T¹ represents —(CH₂)ₚ—, where the chain may be interrupted by —O—, —NR⁹— or —OSiR¹⁰₂O—,

S¹ represents a direct bond, —O—, —S— or —NR⁹—,

p represents an integer from 2 to 12, preferably from 2 to 8, especially from 2 to 4,

R⁹ represents hydrogen, methyl, ethyl or propyl,

R¹⁰ represents methyl or ethyl, and

R⁵ to R⁸ are as defined above.

The covalent binding of monomers of the above-described main-chain basic structures with the azo dyes of formula (I) by way of spacers yields dye monomers. Preferred dye monomers for polyacrylates or polymethacrylates have the formula (II)

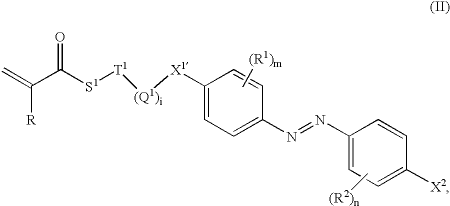

wherein

R represents hydrogen or methyl, and

the other radicals are as defined above.

Particularly suitable are dye monomers of the above formula (II) wherein

X² represents CN, nitro and all other known electron-withdrawing substituents, in which case R¹ is preferably also CN,

and the radicals R, S¹, T¹, Q¹, X^{1′} and R² as well as i, m and n are as defined above.

Also suitable are dye monomers of the following formula (IIa)

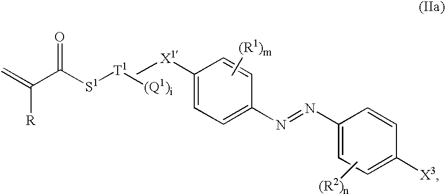

wherein

X³ represents hydrogen, halogen or C₁- to C₄-alkyl, preferably hydrogen, and

the radicals R, S¹, T¹, Q¹, X^{1′}, R¹ and R² as well as i, m and n are as defined above.

Also suitable are dye monomers of formula (IIb)

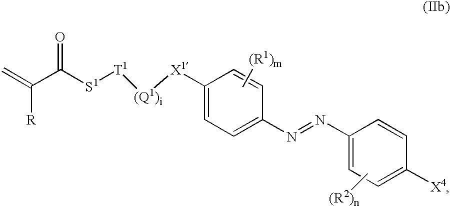

wherein

X⁴ represents cyano or nitro, and

the radicals R, S¹, T¹, Q¹, X^{1′}, R¹ and R² as well as i, m and n are as defined above.

Preferred monomer units with azo dyes that carry a solubility-improving component at the site of binding to the spacer and/or at the free site have the form:

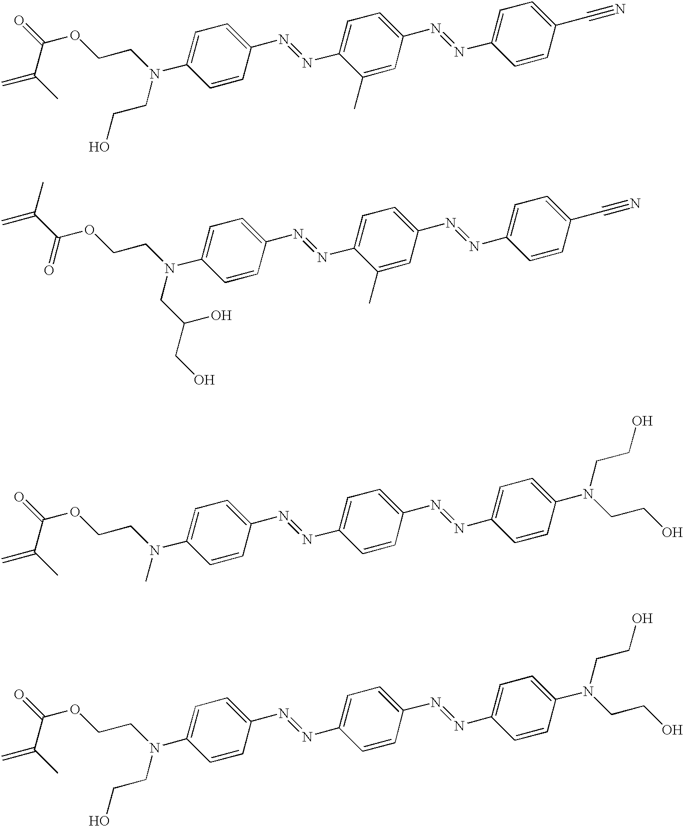

Mesogenic groups preferably have the structure of formula (III)

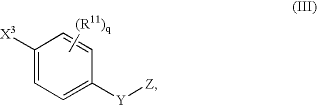

wherein Z represents a radical of formula

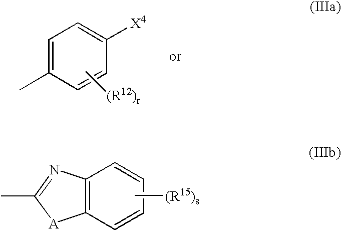

wherein

A represents O, S or N-C₁- to C₄-alkyl,

X³ represents a spacer group of the formula —X^{3′}—(Q²)ⱼ—T²—S²—,

X⁴ represents X^{4′}—R¹³,

X^{3′} and X^{4′} each independently of the other represents a direct bond, —O—, —S—, —(N—R⁵)—, —C(R⁶R⁷)—, —(C═O)—, —(CO—O)—, —(CO—NR⁵)—, —(SO₂)—, —(SO₂—O)—, —(SO₂—NR⁵)—, —(C═NR⁸)— or —(CNR⁸—NR⁵)—,

R⁵, R⁸ and R¹³ each independently of the others represents hydrogen, C₁- to C₂₀-alkyl, C₃- to C₁₀-cycloalkyl, C₂- to C₂₀-alkenyl, C₆- to C₁₀-aryl, C₁to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C10-aryl-(SO₂)—, or

X^{4′}—R¹³ may represent hydrogen, halogen, cyano, nitro, CF₃ or CCl₃,

R⁶ and R⁷ each independently of the other represents hydrogen, halogen, C₁to C₂₀-alkyl, C₁- to C₂₀-alkoxy, C₃- to C₁₀-cycloalkyl, C₂- to C₂₀-alkenyl or C₆- to C₁₀-aryl,

Y represents a single bond, —COO—, OCO—, —CONH—, —NHCO—, —CON(CH₃)—, —N(CH₃)CO—, —O—, —NH—or —N(CH₃)—,

R¹¹, R¹², R¹⁵ each independently of the others represents hydrogen, halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O-(C═O)—, C₁- to C₂₀-alkyl-NH—(C═O)— or C₆- to C₁₀-aryl-NH—(C═O)—,

q, r and s each independently of the others represents an integer from 0 to 4, preferably from 0 to 2,

Q² represents —O—, —S—, —(N—R⁵)—, —C(R⁶R⁷)—, —(C═O)—, —(CO—O)—, —(CO—NR₅)—, —(SO₂)—, —(SO₂—O—)—, —(SO₂—NR⁵)—, —(C═NR⁸)—, —(CN R⁸—NR⁵)—, —(CH₂)ₚ—, p- or m-C₆H₄— or a divalent radical of the formula

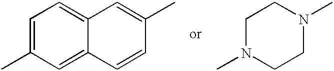

j represents an integer from 0 to 4, with the proviso that the individual Q¹ to have different meanings when j>1,

T² represents —(CH₂)ₚ—, wherein the chain may be interrupted by —O—, —NR⁹— or —OSiR¹⁰₂O—,

S² represents a direct bond, —O—, —S—or —NR₉—,

p represents an integer from 2 to 12, preferably from 2 to 8, especially from 2 to 4,

R⁹ represents hydrogen, methyl, ethyl or propyl, and

R¹⁰ represents methyl or ethyl.

Preferred monomers, having such groupings with anisotropy of form, for polyacrylates or polymethacrylates have, then, the formula (IV)

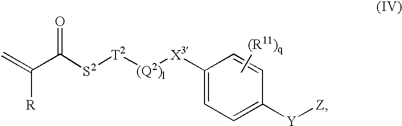

wherein

R represents hydrogen or methyl, and

the other radicals are as defined above.

The alkyl, cycloalkyl, alkenyl and aryl radicals may themselves be substituted by up to 3 radicals from the group halogen, cyano, nitro, C₁- to C₂₀-alkyl, C₁- to C₂₀-alkoxy, C₃- to C₁₀-cycloalkyl, C₂- to C₂₀-alkenyl or C₆- to C₁₀-aryl, and the alkyl and alkenyl radicals may be straight-chain or branched.

Halogen is to be understood as being fluorine, chlorine, bromine or iodine, especially fluorine or chlorine.

In addition to the said functional units, the polymers according to the invention may also contain units which serve mainly to lower the percentage content of functional units, especially of dye units. In addition to the said function, they may also be responsible for other properties of the polymers, such as, for example, the glass transition temperature, liquid crystallinity, film-forming property, etc.

For polyacrylates or polymethacrylates, such monomers are acrylic or methacrylic acid esters of formula (V)

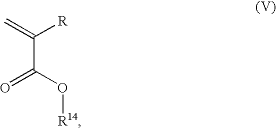

wherein

R represents hydrogen or methyl, and

R¹⁴ represents optionally branched C₁- to C₂₀-alkyl or a radical containing at least one further acrylic unit.

However, it is also possible for other copolymers to be present.

The monomer units for improving the solubility have the following structure of formula (VI)-(VIa):

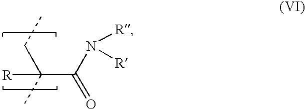

wherein

R′ and R″ either each independently of the other represents CₙH₂ₙ₊₁ or CₙH₂ₙ—OH, wherein n=from 1 to 10, preferably n=from 1 to 3, or together represent a —CₙH₂ₙ bridge wherein n=from 2 to 6, preferably n=from 4 to 5, a —(C₂H₄—O)_{n—C}₂H₄ bridge wherein n=from 1 to 5, preferably n=from 1 to 3, a —C₂H₄—N(CₙH₂ₙ₊₁)—C₂H₄ bridge wherein n=from 1 to 6, preferably n=from 1 to 3,

wherein R=H or CH₃,

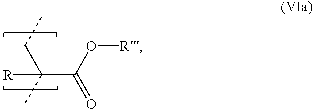

wherein

R′″ represents the radical —CₙH₂ₙ—OH, wherein n=from 1 to 10, preferably n=from 2 to 3, the radical —(C₂H₄—O)ₙ—H, wherein n=from 2 to 4, preferably n=2, the radical —CₙH₂ₙ—C(═O)NR″″R′″″,

wherein n=from 2 to 10, preferably n=from 2 to 5, particularly preferably n=2, where

R″″ and R′″″ either each independently of the other represents CₙH₂ₙ₊₁ or CₙH₂ₙ—OH, wherein n=from 1 to 10, preferably n=from 1 to 3, or together represent a —CₙH₂ₙ bridge wherein n=from 2 to 6, preferably n=from 4 to 5, a —(C₂H₄—O)ₙ—C₂H₄ bridge wherein n=from 1 to 5, preferably n=from 1 to 3, a —C₂H₄—N(CₙH₂ₙ)—C₂H₄ bridge wherein n=from 1 to 6, preferably n=from 1 to 3,

wherein R=H or CH₃.

Polyacrylates, polymethacrylates and poly(meth)acrylates/poly(meth)acrylamides according to the invention then preferably contain as repeating units those of formula (VII), preferably those of formulae (VII) and (VIII) or of formulae (VII) and (IX) or those of formulae (VII), (VIII) and (IX)

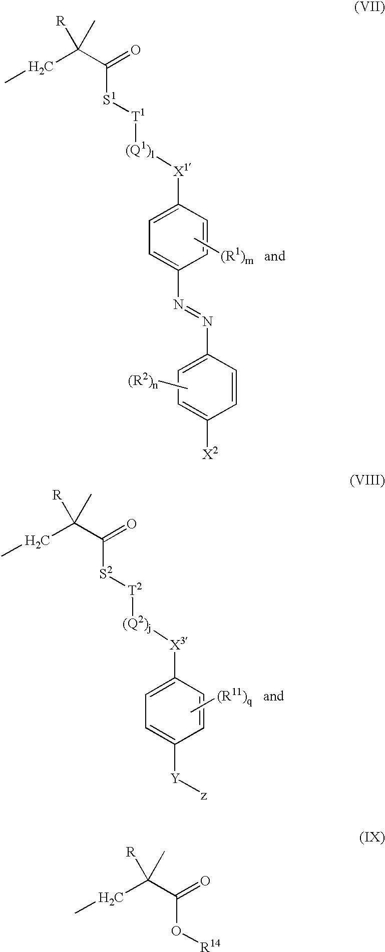

or, instead of formula (VII), repeating units of formula (VIIa) or (VIIb)

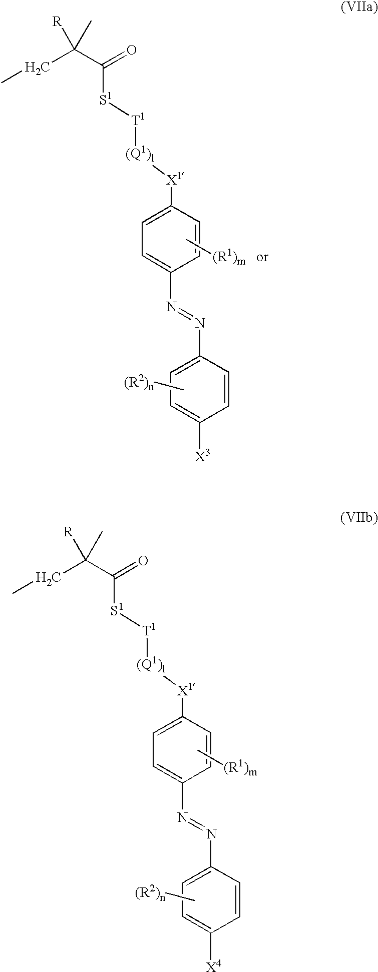

wherein the radicals are as defined above. It is also possible for a plurality of the repeating units of formula (VII) and/or of the repeating units of formulae (VII) and/or (IX) to be present. Monomer units of formula (V) may additionally also be present. Likewise, monomer units of formula (VI) may additionally also be present.

The relative proportions of V, VI, VII, VIII and IX are as desired. The concentration of VII is preferably from 1 to 99%, based on the mixture in question. The ratio between VII and VIII is from 1:99 to 99:1, preferably from 10:90 to 90:10, most particularly preferably from 60:40 to 40:60. The proportion of V is from 0 to 90%, preferably from 20 to 80%, particularly preferably from 30 to 70%, based on the mixture in question. The proportion of VI is from 0 to 90%, preferably from 20 to 80%, particularly preferably from 30 to 70%, based on the mixture in question.

By means of the structure of the polymers and oligomers, the intermolecular interactions of the structural elements of formula (VII) with one another or of formulae (VII) and (VIII) with one another are so adjusted that the formation of liquid crystal order states is suppressed and optically isotropic, transparent, non-scattering films, foils, sheets or parallelepipeds, especially films or coatings, may be produced. On the other hand, the intermolecular interactions are nevertheless sufficiently strong that, on irradiation with light and/or under the action of static electric fields, a photochemically induced, cooperative, directed reorientation process of the light-active and non-light-active side groups is effected.

The interactive forces that occur between the side groups of the repeating units of formula (VII) and between those of formulae (VII) and (VIII) are preferably sufficient that the change in configuration of the side groups of formula (VII) effects a reorientation of the other side groups ((VII) and/or (VII)) in the same direction—so-called cooperative reorientation.

The preparation of the polymers and oligomers may be carried out according to processes known in the literature, for example according to DD-A 276 297, DE-A 3 808 430, Makromolekulare Chemie 187, 1327-1334 (1984), SU-A 887 574, Europ. Polym. 18, 561 (1982) and Liq. Cryst. 2, 195 (1987).

A further method of preparing the recording material or the NLO polymer according to the invention comprises a process in which at least one monomer is polymerized without further solvent, the polymerization preferably being free-radical polymerization and particularly preferably being initiated by free-radical initiators and/or by UV light and/or thermally.

The reaction is carried out at temperatures of from 20° C. to 200° C., preferably from 40° C. to 150° C., particularly preferably from 50° C. to 100° C. and most particularly preferably at about 60° C.

In a particular embodiment, AIBN (azoisobutyronitrile) is used as the free-radical initiator.

It has often proved advantageous to use concomitantly a further, preferably liquid, monomer. Such monomers are to be understood as being monomers that are liquid at the reaction temperatures, which are preferably olefinically unsaturated monomers, particularly preferably based on acrylic acid and methacrylic acid, most particularly preferably methyl methacrylate.

### EXAMPLE 1

### Synthesis of Monomers

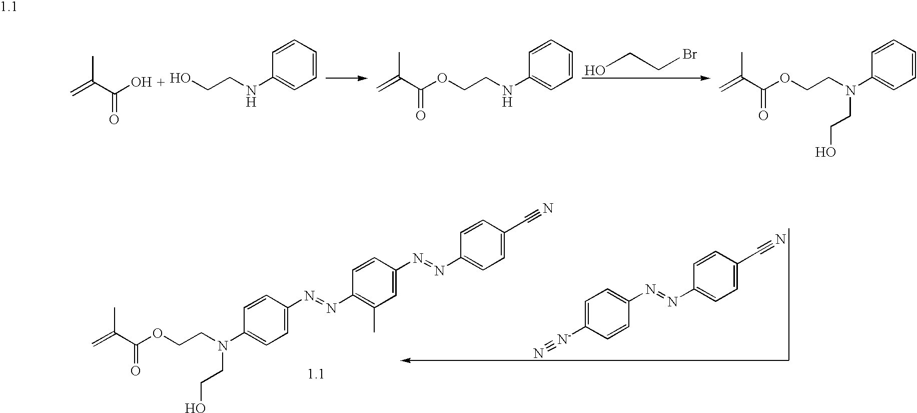

200 g of 2-anilinoethanol, 580 ml of methacrylic acid and 115.6 g of hydroquinone and 880 ml of chloroform are brought to reflux, with stirring. 148 ml of conc. sulfuric acid are slowly added dropwise. The water of reaction is removed azeotropically. After cooling, water is added to the reaction mixture and a pH of 6 is established using concentrated aqueous soda solution. The organic phase is separated off, and the solvent is concentrated using a rotary evaporator. The product is purified by chromatography (silica gel; methylene chloride). Yield of N-[2-(methacryloyloxy)ethyl]-aniline is 112 g (34% of the theoretical yield).

30 g of 2-bromoethanol are placed in a reaction vessel at 70° C. in an argon atmosphere. 30 g of N-[2-(methacryloyloxy)ethyl]-aniline are slowly added. The reaction mixture is then stirred for 24 hours at 100° C.; after cooling, it is introduced into chloroform and washed with water. After drying with magnesium sulfate, chloroform is removed and the product is purified by chromatography (aluminum oxide; dioxan). The yield of N-(hydroxyethyl)-N-[2-(methacryloyloxy)ethyl]-aniline is 10.2 g (28%).

Elemental analysis: C₁₄H₁₉NO₃ (249.31)

calc.: C, 67.45; H, 7.68; N, 5.62; found: C, 67.30; H, 7.40; N, 5.60

5.7 g of 4-amino-3-methyl-4′-cyanoazobenzene are placed in a mixture of 40 ml of acetic acid and 13 ml of hydrochloric acid at 5° C., diazotised by the slow addition of 8.6 g of 30% sodium nitrite solution, and coupled to 6 g of N-(hydroxyethyl)-N-[2-(methacryloyloxy)ethyl]-aniline in 200 ml of methanol at 15° C. The pH value of from 2.0 to 2.5 is maintained by addition of sodium acetate. The precipitate is filtered off after one hour's stirring, washed with water and methanol, dried and filtered in dioxan through a layer of aluminium oxide. The yield of 1.1 is 6.2 g. M.p. 148° C.

Elemental analysis: C₂₈H₂₈N₆O₃ (496.57)

calc.: C, 67.73; H, 5.68; N 16.92; found: C, 67.80; H, 5.70; N, 16.70

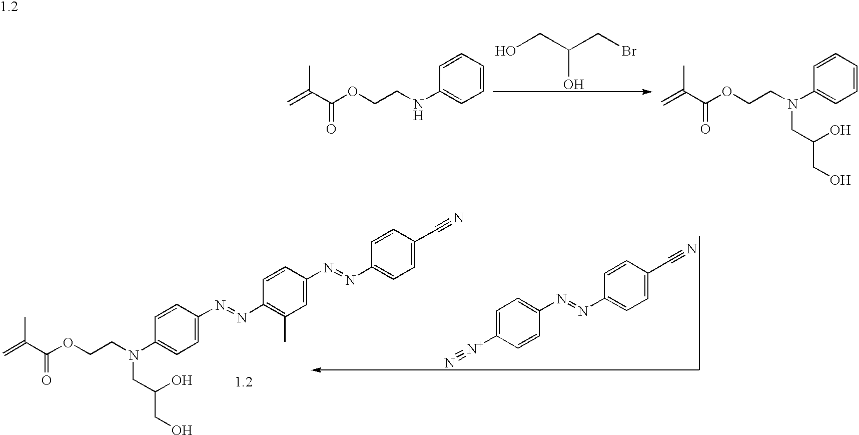

N-(2,3-Dihydroxypropyl)-N-[2-(methacryloyloxy)ethyl]-aniline is prepared analogously to 1.1 from 3-bromo-1,2-propanediol and N-[2-(methacryloyloxy)ethyl]-aniline. The product is purified by chromatography (aluminium oxide; first toluene/dioxan=1:1; then dioxan). The yield is 28%.

Monomer 1.2 is prepared analogously to 1.1 by diazotisation of 4-amino-3-methyl-4′-cyanoazobenzene and coupling to N-(2,3-dihydroxypropyl )-N-[2-(methacryloyloxy)ethyl]-aniline. Purification by chromatography takes place on silica gel in toluene/dioxan=1:1. The yield is 30%. M.p. 148° C.

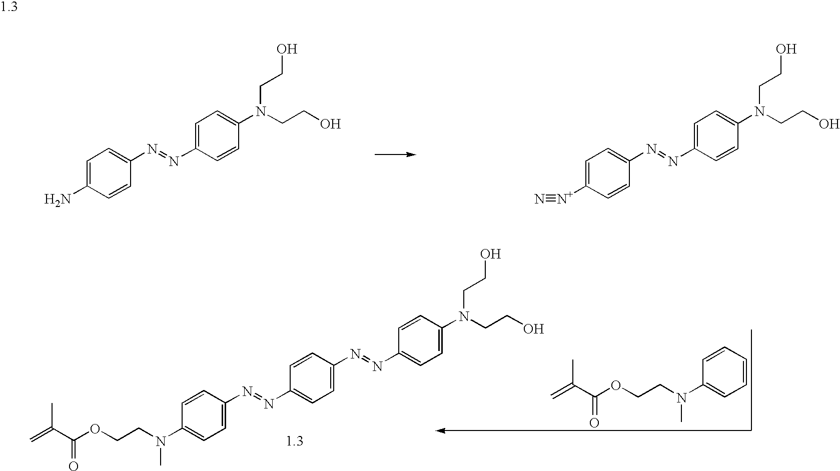

10.7 g of 2,2′-[4-(4-aminophenylazo)-phenylimino]-diethanol are placed in a mixture of 60 ml of water and 20 ml of hydrochloric acid at 5° C., diazotised by the slow addition of 12.8 g of 30% sodium nitrite solution, and coupled to 10 g of N-methyl-N-[2-(methacryloyloxy)ethyl]-aniline in 300 ml of methanol at 15° C. The pH value of 2.7 is maintained by addition of sodium acetate. The precipitate is filtered off after one hour's stirring, washed with water, dried and recrystallized from xylene. The yield of 1.3 is 7.2 g. M.p. 149° C.

Elemental analysis: C₂₉H₃₄N₆O₄ (530.63)

calc.: C, 65.64; H, 6.46; N, 15.84; found: C, 65.70; H, 6.40; N, 15.70

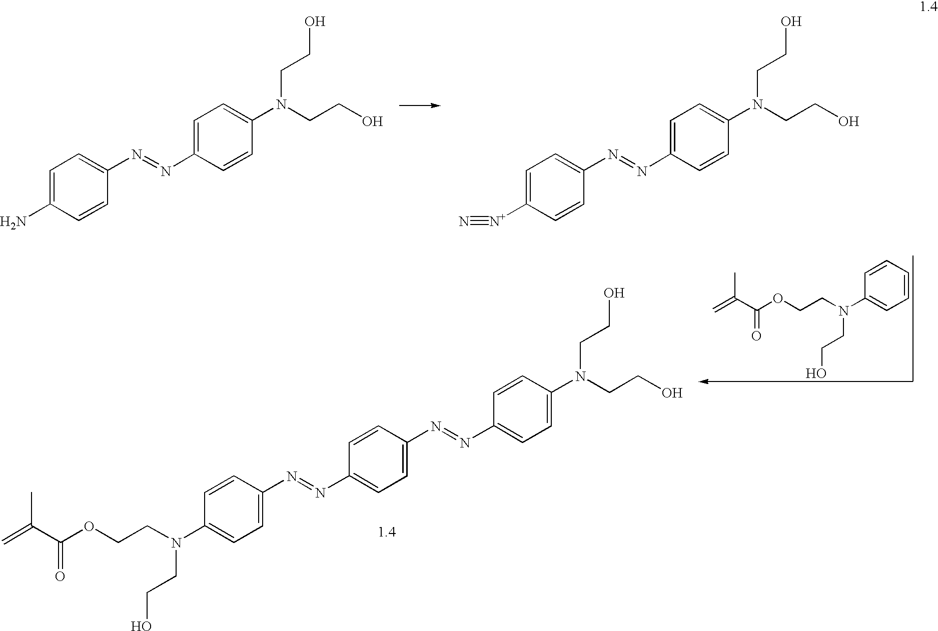

12.8 g of 2,2′-[4-(4-aminophenylazo)-phenylimino]-diethanol are placed in a mixture of 60 ml of water and 20 ml of hydrochloric acid at 5° C., diazotised by the slow addition of 15.2 g of 30% sodium nitrite solution, and coupled to 10.6 g of N-(hydroxyethyl)-N-[2-(methacryloyloxy)ethyl]-aniline in 300 ml of methanol at 15° C. The pH value of 2.7 is maintained by addition of sodium acetate. The precipitate is filtered off after one hour's stirring, washed with water, dried and recrystallized from xylene. The yield of 1.4 is 15 g. M.p. 105° C.

Elemental analysis: C₃₀H₃₆N₆O₅ (560.66)

calc.: C, 64.27; H, 6.47; N, 14.99; found: C, 64.10; H, 6.40; N, 14.20

### EXAMPLE 2

### Suitable Solvents

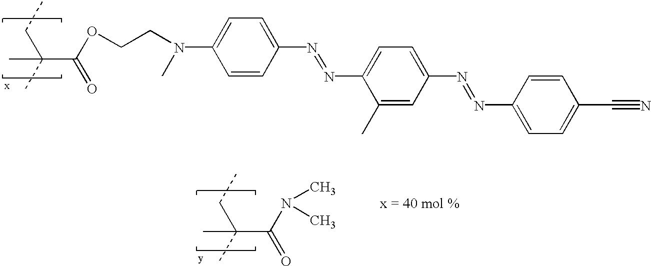

The polymer shown was synthesised according to Example 1. It has a molecular weight, determined as the weight-average, of 13,270 g/mol (measuring method: gel permeation chromatography using N,N-dimethylacetamide as solvent. Evaluation on the basis of a calibration equation valid for PMMA at 60° C. in N,N-dimethylacetamide).

The polymer has a glass transition temperature of 120° C. (measuring method: heat flow calorimetry at a heating rate of 20 K/min).

The polymer 1 dissolves completely at a concentration of 2% in 2,2,3,3-tetrafluoropropanol (TFP) and tetrahydrofuran (THF).

### EXAMPLE 3

### Preparation and Poling of Thin Films

Preparation

After the drying process, the polymer from Example 2 is ground to a powder. In a further step, the powder is dissolved. Tetrahydrofuran (THF) is used as the solvent. The solution must then be filtered (0.2 μm pore size) before it is applied by spin coating to an object holder (about 2×2 cm²) coated with indium-tin oxide (ITO). In this method, the object holder is made to rotate (about 2000 revolutions/sec) and a drop of the solution is placed in the centre, which drop spreads as a result of the centrifugal force. The solvent evaporates, and the polymer cures fully on the object holder. It is thus possible to produce very thin and smooth layers. The layer thickness is dependent on the concentration of solvent and on the speed of rotation. The polymer films used are about 0.5 μm thick.

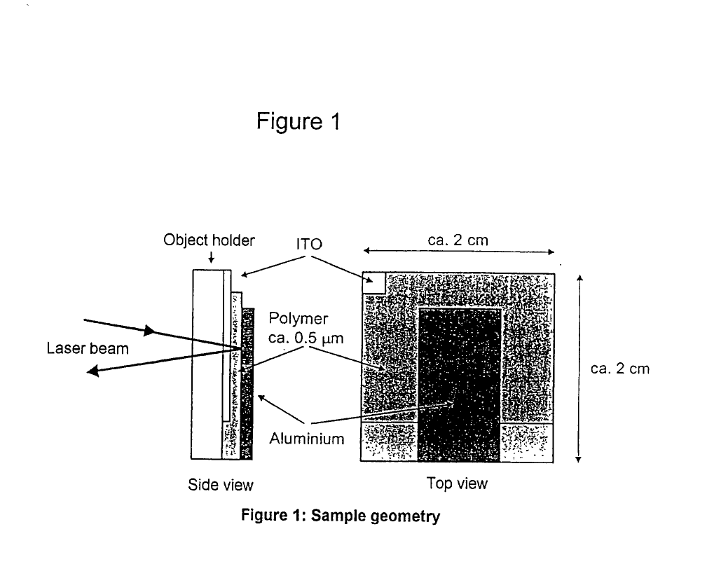

Only after poling, which is discussed separately hereinbelow, are the samples given a covering electrode of aluminium. The temperatures occurring in the process of deposition by evaporation are below 60°, so that the molecular order induced by poling is maintained fully. The thickness of the aluminium layer varies between 400 and 600 nm. The aluminium covers only a strip in the centre of the polymer, so that scratches caused by the holding device cannot lead to a short-circuit and thus result in impairment of the measurements (see FIG. 1).

Poling

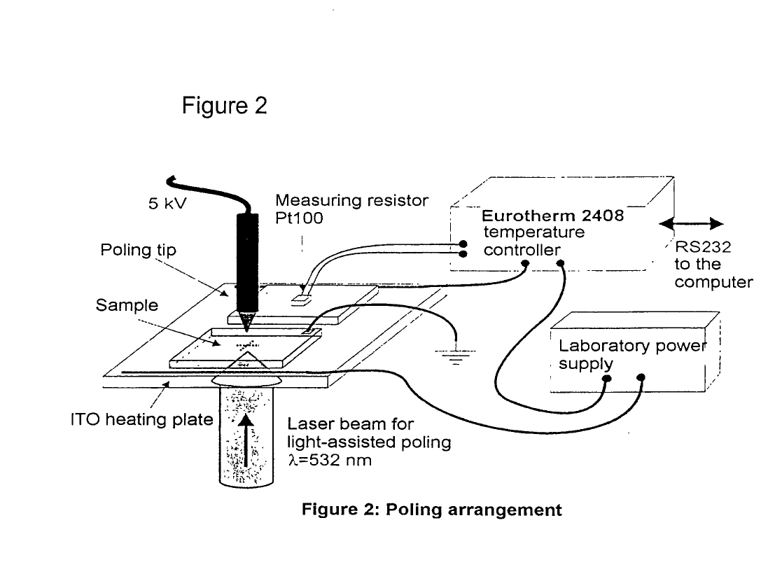

Only as a result of the poling does the material acquire a marked orientation, and the molecular hyperpolarizabilities add up to a net polarization. The higher the degree of orientation, the greater the electrooptical coefficients that are to be expected. FIG. 2 shows the arrangement for thermal poling using corona discharge.

Poling Takes Place in Five Steps

1. applying the voltage to the poling tip, as a result of which a field forms perpendicularly to the surface of the sample

2. heating the sample to just above the glass transition temperature

3. maintaining the temperature for 15 minutes

4. slowly cooling the sample to room temperature

5. cutting off the poling field.

The corona poling method is used for poling the samples. In that method, a tip is placed at a distance of from 7 to 10 mm above the sample. A voltage of +5 kV is then applied to the tip against the ITO electrode, which is at earth potential. By means of corona discharge, the surrounding air molecules are ionised and migrate to the surface of the sample. There they collect, and there forms in the polymer film an electric field which, because of the relatively great distance of the poling tip, may be assumed to be homogeneous (remote field approach). The outer electric field establishes a preferred direction and orientates the chromophores, whose property as a molecular dipole is utilised.

For heating, the object holder with the polymer is fastened to a further ITO glass plate. This serves as a heating plate and is supplied with a constant voltage of 29 V by a laboratory power supply. As a result of the heating, the mobility of the polymer molecules, and hence also that of the chromophores, increases. The temperature is adjusted to a predetermined value by means of a relay controller. The temperature is controlled by way of a measuring resistor (Pt100 element) which is bonded to a further object holder in order to simulate the situation at the surface of the sample. The temperature is first increased slowly until the poling temperature, which is a few ° C. above the glass transition temperature, is reached. The temperature is then maintained constant for 15 minutes before being slowly cooled to room temperature again. The chromophores aligned in the outer field are thus frozen in the polymer matrix. Only then is the poling voltage cut off, and the field collapses.

The polymer film poled by the said method exhibits electrooptical coefficients of r₃₃=36 pm/V, which is slightly greater than that of technologically relevant crystals such as LiNbO₃ (33 pm/V). The measuring arrangement for evaluating the r coefficient is described in Example 5.

### EXAMPLE 4

### Light-assisted Poling

The efficiency of the uniaxial orientation may additionally be improved by illumination with light of a suitable wavelength and intensity during poling or before poling (used in this case: wavelength λ=532 nm, intensity 100 mW/cm², circularly polarized, preferably 1-5 min) parallel to the electric field.

Before corona poling in a first experiment and during corona poling in a second experiment, light was irradiated from the substrate side in perpendicular incidence (see FIG. 2). As a result of the action of light, azobenzenes were constantly excited in the film plane and undergo cis-trans isomerization cycles. These geometric forces led to increased mobility of the light-active molecules. In conjunction with the electric poling field, which brings about a preferred direction, more effective poling of the material is achieved than by means of purely electrical or purely light-induced poling.

Corresponding poling tests have shown that the electrooptical coefficients may be approximately tripled as a result of the light assistance.

### EXAMPLE 5

### Interferometer (Mach-Zehnder) Arrangement for Measuring Electrooptical Coefficients

The measuring method used here is Mach-Zehnder interferometry. In that method, the relative difference of phase of two light beams which are made to interfere is determined. The phase shift in one arm of the interferometer is caused by the electric field applied to the polymer and the associated change in refractive index by way of the electrooptical effect.

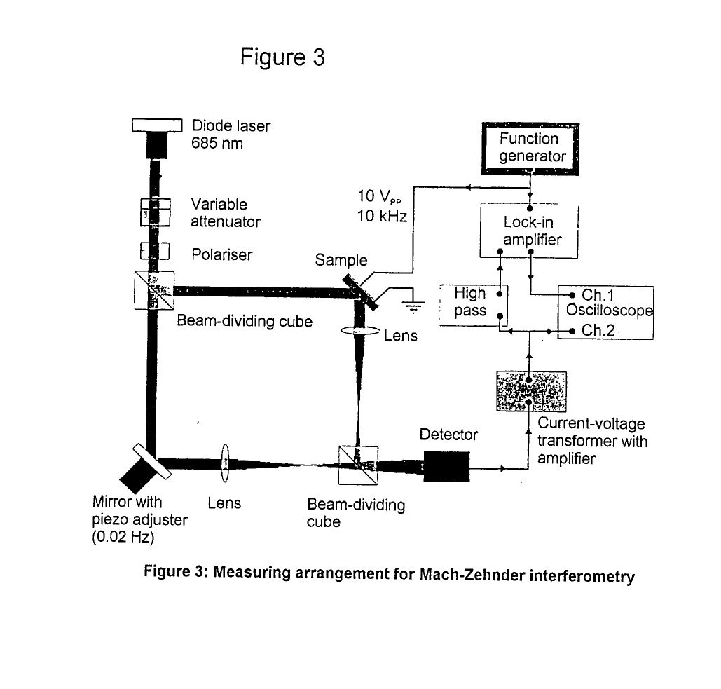

The electrooptical coefficients r₁₃ and r₃₃ may be determined from the size of the phase shift. The arrangement is shown in FIG. 3. The light source used is a diode laser having a wavelength of 685 nm. In order to determine the r₁₃ value, the polarizer incorporated upstream of the beam divider must be set to vertical polarization (s polarization), while two measurements are necessary to determine the r₃₃ value: one with vertical (s) polarization and one with parallel (p) polarization.

Details regarding this measuring arrangement have been published by Buse et al. [K. Buse et al., Optics Communications 131, 339-342 (1996)]; see also the references contained therein.

The accuracy of the measuring arrangement was tested with a LiNbO₃ crystal, in order to ensure that correct values are given for the electrooptical coefficients. It was possible to reproduce the literature values with a deviation of less than 10%. Furthermore, simply by rotating the sample and using the aluminium electrode directly as a mirror, it was possible to check whether the electrostrictive effects are so strong that they are able to effect stretching of the sample and hence falsification of the measurement. Such falsifications are less than 1% and therefore have no significant influence on the measurement results.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An electrooptical component comprising a side-chain polymer having nonlinear optical properties, the polymer containing
a) at least one azobenzene-based dye,
b) at least one mesogenic grouping,
c) optionally at least one additional monomer unit,
d) optionally a solubility-improving monomer unit,
with the proviso that b) is optional in the embodiments where the azobenzene-based dye is mesogenic.

2. An electrooptical component comprising a side-chain polymer having nonlinear optical properties, the polymer containing
a) at least one azobenzene dye,
b) at least one grouping having anisotropy of form,
c) at least one monomer selected from the group consisting of (VI) and (VIa), where (VI) conforms to 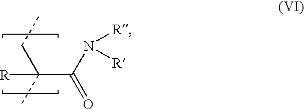
wherein
R′ and R″ either each independently of the other represents CₙH₂ₙ₊₁ or CₙH₂ₙ—OH, wherein n=from 1 to 10, or together represent a —CₙH₂ₙ bridge wherein n=from 2 to 6, a —(C₂H₄—O)ₙ—C₂H₄ bridge wherein n=from 1 to 5, a —C₂H₄—N(CₙH₂ₙ₊₁)—C₂H₄ bridge wherein n=from 1 to 6, and
R=H or methyl,
and where (Via) conforms to 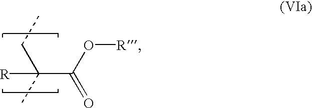
wherein
R′″represents the radical —CₙH₂ₙ—OH, wherein n=from 1 to 10, the radical —(C₂H₄—O)ₙ—H, wherein n=from 2 to 4, the radical —CₙH₂ₙ—C(═O)NR″″R′″″,
wherein n=from 2 to 10, where
R″″ and R′″″ either each independently of the other represents CₙH₂ₙ₊₁ or CₙH₂ₙ—OH, wherein n=from 1 to 10, or together represent a —CₙH₂ₙ bridge wherein n=from 2 to 6, a —(C₂H₄—O)ₙ—C₂H₄ bridge wherein n=from 1 to 5, a —C₂H₄—N(CₙH₂ₙ₊₁)—C₂H₄ bridge wherein n=from 1 to 6, and
R=H or methyl, and
d) optionally further monomer units which are incorporated for the targeted reduction of the dye and/or mesogen content in the polymer.

3. The electrooptical component of claim 1 wherein a) and/or b) carry hydroxyethyl groups and c) is omitted.

4. The electrooptical component of claim 1 wherein the dye contains at least one molecule that
a) has a hyperpolarizability β of (100 to 5000)×10⁻³⁰ esu,
b) is light-active in the sense that absorbed light induces isomerization cycles between the linear trans and the angular cis state, so that the mobility and/or the orientation of the dye molecule in the poling field is improved by the action of light, as an overall average by typically from 15 to 50%, to be read off at the order parameter <cos³ θ>.

5. The electrooptical component of claim 1 wherein the mesogenic grouping has anisotropy of form which is characterized in that the length-breadth ratio, measured at the van-der-Waals radii, is at least 4.

6. The electrooptical component of claim 1 wherein said a) and said b) are bonded to the polymer chain by way of a spacer.

7. The electrooptical component of claim 1 wherein the side-chain polymer is photoaddressable in the sense that its poling efficiency can be increased by the action of light.

8. The electrooptical component of claim 1 wherein the side-chain polymer films are in an amorphous state.

9. The electrooptical component of claim 1 in the form of a flat structure.

10. A process for producing an electrooptical component comprising dissolving a side-chain polymer having nonlinear optical properties, the polymer containing a) at least one azobenzene-based dye, b) at least one mesogenic grouping, c)optionally at least one additional monomer unit, d) optionally a solubility-improving monomer unit, with the proviso that b) is optional in the embodiments where the azobenzene-based dye is mesogenic, and forming a homogeneous film.

11. The electrooptical component of claim 1 in the form of a modulator.

12. The electrooptical component of claim 1 in the form of a piezoelectric sensor.

13. The electrooptical component of claim 1 in the form of an electrostrictive actuator.

14. A process of producing an electrooptical component comprising poling a side-chain polymer having nonlinear properties by means of an electric field and optionally additionally by the action of light, the nonlinear optical, said polymer containing
a) at least one azobenzene-based dye,
b) at least one mesogenic grouping,
c) optionally at least one additional monomer unit,
d) optionally a solubility-improving monomer unit,
with the proviso that b) is optional in the embodiments where the azobenzene-based dye is mesogenic.
